(19) United States
(12) Patent Application Publication
(10) Pub. No.: US 2017/0316631 A1
(43) Pub. Date: Nov. 2, 2017

(54) POLLING SYSTEMS AND METHODS

(71) Applicant: BEK HOLDINGS, LLC, Reston, VA (US)

(72) Inventors: Bekim VESELI, Reston, VA (US); Vikram PANT, Olney, MD (US); Spencer JOHNSON, Washington, DC (US)

(73) Assignee: BEK HOLDINGS, LLC, Reston, VA (US)

(21) Appl. No.: 15/492,743

(22) Filed: Apr. 20, 2017

Related U.S. Application Data
(60) Provisional application No. 62/328,331, filed on Apr. 27, 2016.

(51) Int. Cl. G07C 13/00; H04W 4/14; G06F 17/30

(52) U.S. Cl. CPC G07C 13/00; G06F 17/3056; H04W 4/14

(57) ABSTRACT

An application server may receive poll creation data comprising a poll identifier, a poll question string, at least two answer identifiers and associated answer strings, and data identifying at least one recipient. The application server may generate a plurality of unique data based on at least a portion of the poll creation data, the plurality of unique data enabling the identification of each of a plurality of poll message recipients. The application server may generate a poll message comprising at least a portion of the poll creation data. The application server may send the poll message to each of the plurality of poll message recipients. The application server may receive at least one poll response. The application server may use the plurality of unique data to identify at least one sender of the at least one poll response and a selected poll answer.

### CROSS-REFERENCE TO RELATED APPLICATION

This application claims the benefit of priority from U.S. Provisional Application No. 62/328,331, filed Apr. 27, 2016, the entirety of which is incorporated by reference herein.

### BRIEF DESCRIPTION OF THE DRAWINGS

FIG. 1 is a polling system according to an embodiment of the invention.

FIG. 2 is a poll creation method according to an embodiment of the invention.

FIGS. 3A-3B show a polling method according to an embodiment of the invention.

FIG. 4 is a poll creation method according to an embodiment of the invention.

FIGS. 5A-5B show a polling method according to an embodiment of the invention.

FIG. 6 is a block diagram of an example computing device that may implement the features and processes of FIGS. 1-5B.

FIG. 7 is a block diagram of an example system architecture that may implement the features and processes of FIGS. 1-5B.

### DETAILED DESCRIPTION OF SEVERAL EMBODIMENTS

Polling may be executed as a one-to-many communication that aims to gather public opinion or sentiment around a single question or topic. The scope of many one-to-many polling campaigns requires systems designed to maximize reach and orchestrate the collection of data across different channels. However, polling may also be conducted on a one-to-one or other small scale basis. For example, SMS/MMS polling may support a single poll with two-way voting with unique answer labels. For example, a system can send an SMS or MMS containing a question or image with answers preceded by unique characters (e.g. “A”) or combinations of characters (e.g. “1A”). The recipient of the message can vote by sending a response containing one of the answer labels. When the response is received, the label may be recognized and counted as a vote for its respective answer.

The systems and methods described herein may enable one-to-one polling and may be capable of supporting multiple poll targets and questions simultaneously. In some example embodiments, a system may send multiple, unique SMS/MMS polls simultaneously to the same voter. The voter's SMS response may uniquely identify who is responding, what their answer is, and which question they are responding to.

System Overview

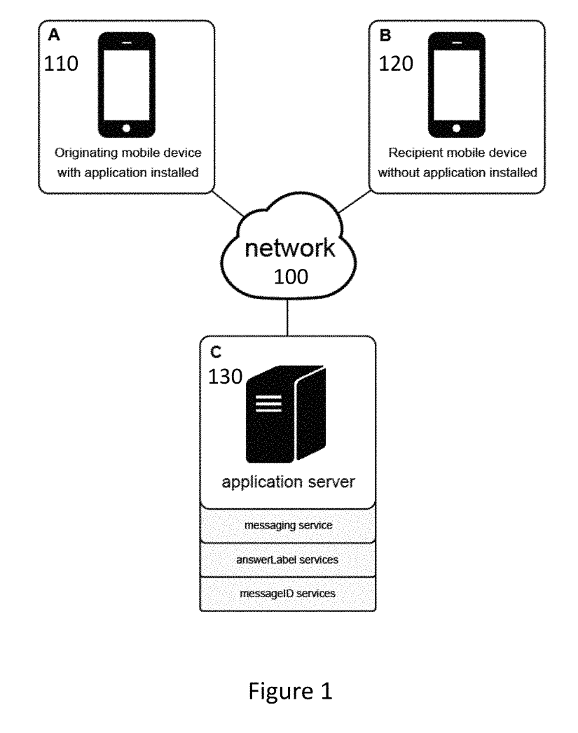

FIG. 1 is a polling system according to an embodiment of the invention. The system may include at least one originating device 110 with a polling application installed, at least one receiving device 120 that may or may not have the polling application installed, and at least one application server 130. These devices may communicate with one another using a network 100 or networks (e.g., the Internet, SMS network, MMS network, etc.).

Originating devices 110 and/or receiving devices 120 may be any of a variety of computing devices such as mobile devices, tablets, personal computers, laptops, etc. Example system architecture for devices configured to function as originating devices 110 and/or receiving devices 120 is described in greater detail below.

Application server 130 may be configured to call services such as messaging services, answerLabel services, and/or messageID services. The messaging services may compose SMS or MMS messages and send composed messages to selected recipients (e.g., one or more receiving devices 120, as discussed below. Example system architecture for devices configured to function as application servers 130 is described in greater detail below.

Polling Methods

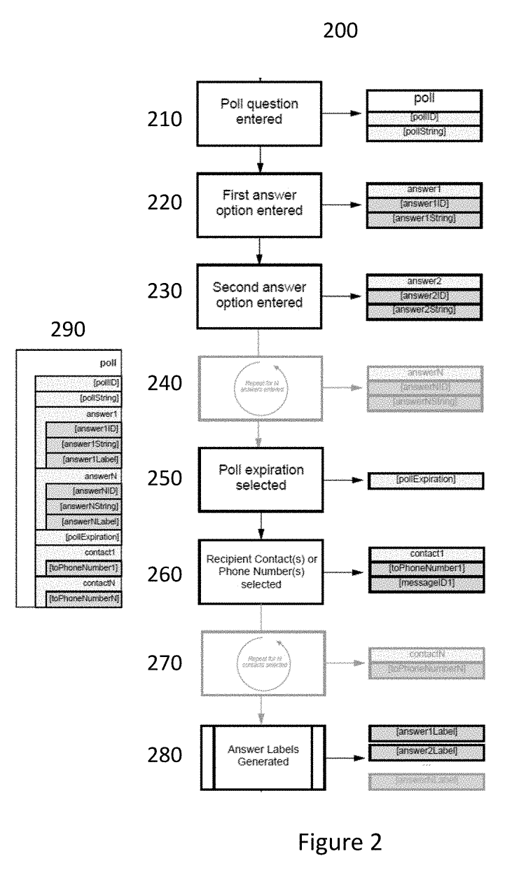

FIG. 2 is a poll creation method 200 according to an embodiment of the invention. Poll creation method 200 may be used to generate polls wherein SMS poll responses may be identified using a unique combination of characters to label answers and an answerID. Mobile device 110 and/or application server 130 may call one or more services 290 to perform method 200. For example, the answerLabel services may manage the answerLabel library by assigning and removing answerIDs and pollExpirations. The answerLabel services may match SMS responses to an answerLabel and translate an SMS response into an answerString. Components may be connected through a global network 100.

Poll creation method 200 may be performed by an application installed on originating mobile device 110, for example. As a user completes each step of the creation process within the application, unique data attributes may be created and stored for future use.

At 210, device 110 may initiate poll creation by receiving the question text from a user input, for example through a device 110 keyboard or touchscreen. At this step, device 110 may create a “poll” object. The poll object may include a pollID (e.g., a unique string of characters that identify this poll) and/or a pollString (e.g., the user-generated string of characters that makes up the question).

At 220, device 110 may receive a first answer option from a user input, for example through a device 110 keyboard or touchscreen. At this step, device 110 may create an “answer” object for the first option. The answer object may include an answerID (e.g., a concatenation of a unique string of characters and the pollID) and/or an answerString (e.g., the user-generated string of characters that makes up the answer).

At 230, device 110 may receive a second answer option from a user input, for example through a device 110 keyboard or touchscreen. At this step, device 110 may create an answer object for the second option. As with the first answer object, the second answer object may include an answerID and/or an answerString.

At 240, device 110 may present an option to the user to enter more questions and answers. If device 110 receives user input to enter more questions and answers, device 110 may repeat steps 210-230 for each question/answer combination. When the user indicates that there are no more questions and answers to be entered, device 110 may proceed with method 200.

At 250, device 110 may receive user input defining when the poll will expire. At this step, device 110 may create a pollExpiration data attribute defining a period of time that, when surpassed, will render the poll inactive.

At 260, device 110 may receive user input defining a phone number or selecting a contact to which the poll is to be sent. At this step, device 110 may create a “contact” object for the contact or phone number provided with a toPhoneNumber attribute. The “poll,” “answer,” and “contact” business objects may be mapped on the back end (e.g., by application server 130) to maintain relationships between the data attributes.

At 270, device 110 may present an option to the user to enter more phone numbers and/or contacts. If device 110 receives user input to enter more phone numbers and/or contacts, device 110 may repeat step 260 for each phone numbers and/or contacts. When the user indicates that there are no more phone numbers and/or contacts to be entered, device 110 may proceed with method 200.

At 280, device 110 may execute an answerLabel service that may retroactively create an answerLabel for each answer option that was created. For example, the answerLabel may include a combination of characters generated from an answer label library. Answer labels may be generated last in this process 200 because there may be a finite number of answer labels, and assigning them earlier may risk them being allocated to abandoned poll answers.

After all steps have been completed, device 110 may send the generated data to application server 130. In some embodiments, step 280 (answerLabel service) may be performed by application server 130. In this case, device 110 may send the generated data to application server 130 after receiving all user data as described above.

Application server 130 may generate an SMS from the pollString, answerLabels, and answerStrings. Application server 130 may send the SMS to each recipient from a phone number or short code utilized by the mobile application's messaging service.

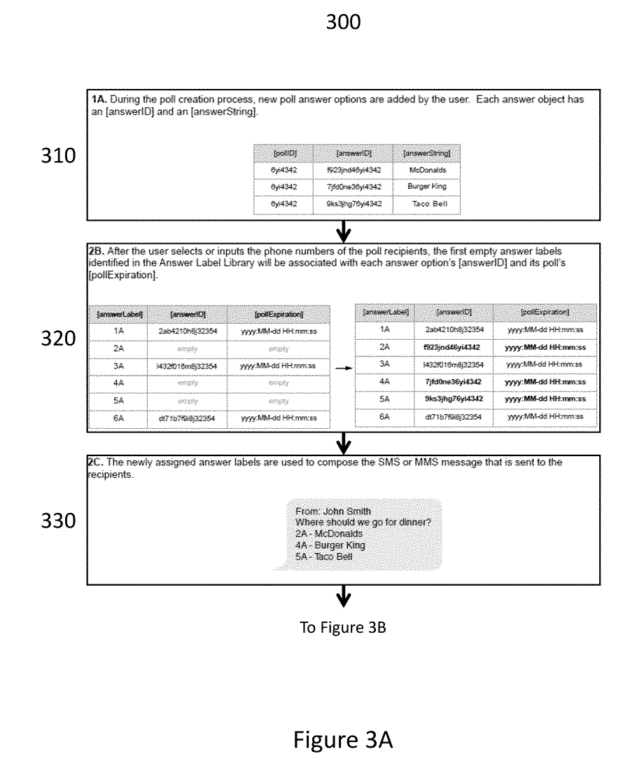

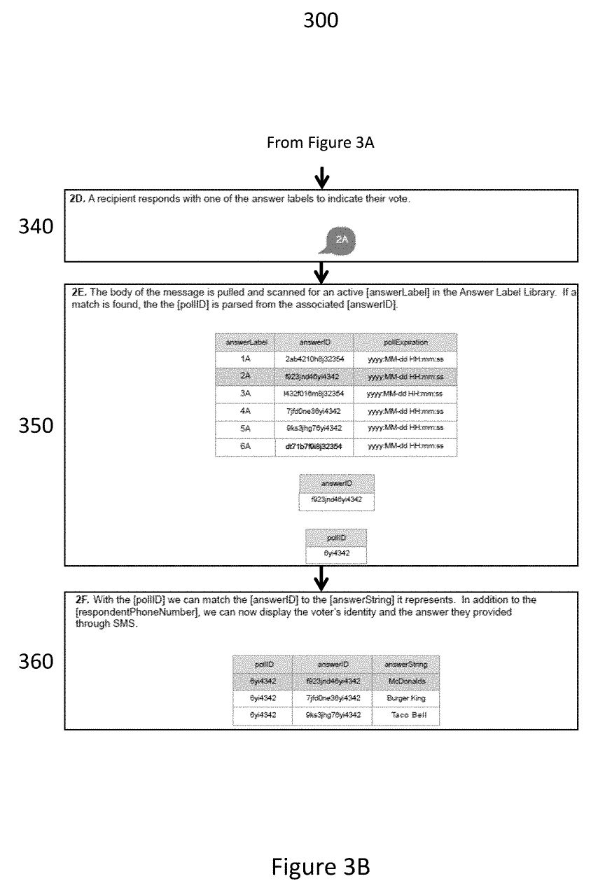

FIGS. 3A-3B show a polling method 300 according to an embodiment of the invention. For example, when device 110 has gathered and sent poll data to application server 130 in the process 200 of FIG. 2, application 130 may perform polling method 300 to generate, send, receive, and determine results for one or more polls.

At 310, application server 130 may receive data from device 110. For example, as shown, application server 130 may receive pollID, answerID, and/or answerString data generated by device 110 as discussed above. Application server 130 may also receive poll expiration and phone number/contact information as discussed above.

At 320, application server 130 may associate answer labels with poll data from device 110. For example, application server 130 may use an answer label library (e.g., stored in a database of application server 130) that tracks temporary associations of answerLabels, answerID's, and pollExpirations. For every answer option added in the poll creation process, a service of application server 130 may access the answer label library to find an answerLabel that is not associated to an active poll (e.g., has null answerID or pollExpiration values). When an unused answerLabel is found, application server 130 may associate the answerID of the answer and the pollExpiration of the poll to the answerLabel. This association may be temporary. For example, when the pollExpiration is reached, a service of application server 130 may clear the answerID and pollExpiration data for the associated answerLabel, rendering the answerLabel available for use in another SMS poll.

At 330, application server 130 may compose the SMS message (or MMS message in some embodiments) to be sent to the specified numbers and/or contacts. As shown in the example of FIG. 3A, application server 130 may insert question and answer string data from device 110 into the message body. Application server 130 may send the composed message to the specified numbers and/or contacts using SMS or MMS messaging.

At 340, application server 130 may receive one or more votes from one or more recipient mobile devices 120. Recipients of the SMS poll can vote by responding with an SMS message containing the answerLabel associated with the answer option they wish to select. When application server 130 receives this message, application server 130 may pull the following data: the phone number that received the response, the phone number of the message's originator, and/or the body of the SMS, for example.

At 350, an answerLabel matching service of application server 130 may scan the body of the SMS for an active answerLabel. Once a matching answerLabel is found, application server 130 may pull the answerID and parse the pollID from the answerID. The answerID may allow application server 130 to find the poll's respective answerString, as both data may be attributes of the same “answer” object.

At 360, with the answerString, pollID, and the voter's phone number known, application server 130 may report the answer option (answerString) and the voter (contact name or number) within the context of a specific poll. For example, application server 130 may save this result in an application server 130 database. Application server 130 may send the result to device 110, and device 110 may display the result in a user interface of the polling application.

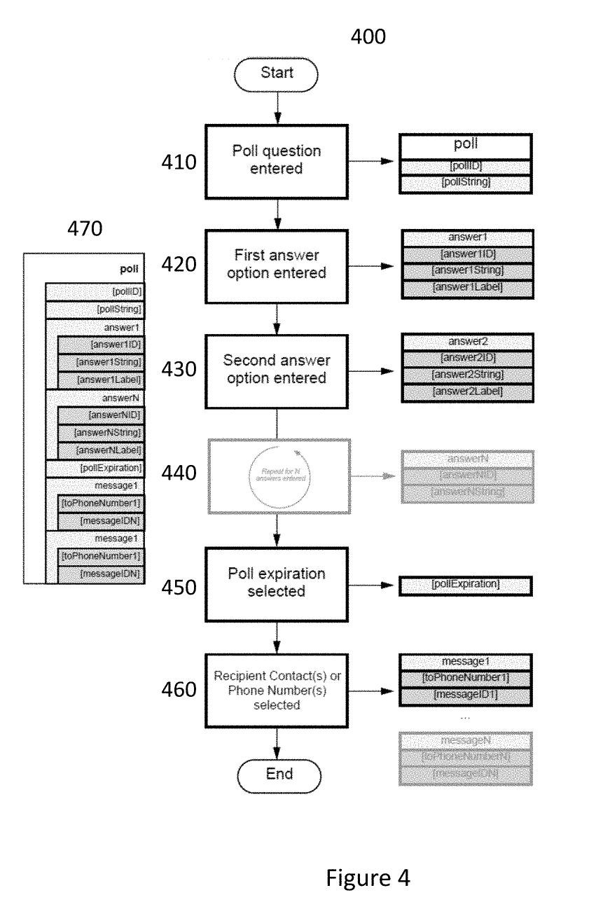

FIG. 4 is a poll creation method 400 according to an embodiment of the invention. Poll creation method 400 may be used to generate poles wherein SMS poll responses may be identified using a unique combination of a number sending the SMS/MMS and a messageID. Mobile device 110 and/or application server 130 may call one or more services 470 to perform method 400. For example, the messageID services may manage the servicePhoneNumber library by adding and removing messageIDs from servicePhoneNumber arrays. The messageID services may match a respondent's phone number to a messageID in the correct servicePhoneNumber arrays. Components may be connected through a global network 100.

Poll creation method 400 may be performed by an application installed on originating mobile device 110, for example. As a user completes each step of the creation process within the application, unique data attributes may be created and stored for future use.

At 410, device 110 may initiate poll creation by receiving the question text from a user input, for example through a device 110 keyboard or touchscreen.

At this step, device 110 may create a “poll” object. The poll object may include a pollID and/or a pollString.

At 420, device 110 may receive a first answer option from a user input, for example through a device 110 keyboard or touchscreen. At this step, device 110 may create an “answer” object for the first option. The answer object may include an answerID, an answerLabel (e.g., numerical “1”, “2”, “3”, etc. or alphabetical “A”, “B”, “C”, etc.), and/or an answerString.

At 430, device 110 may receive a second answer option from a user input, for example through a device 110 keyboard or touchscreen. At this step, device 110 may create an answer object for the second option. As with the first answer object, the second answer object may include an answerID, an answerLabel, and/or an answerString.

At 440, device 110 may present an option to the user to enter more questions and answers. If device 110 receives user input to enter more questions and answers, device 110 may repeat steps 410-430 for each question/answer combination. When the user indicates that there are no more questions and answers to be entered, device 110 may proceed with method 400.

At 450, device 110 may receive user input defining when the poll will expire. At this step, device 110 may create a pollExpiration data attribute defining a period of time that, when surpassed, will render the poll inactive.

At 460, device 110 may receive user input defining one or more phone numbers or selecting one or more contacts to which the poll is to be sent. At this step, device 110 may create a “contact” object for each contact or phone number provided. Device 110 may create a toPhoneNumber attribute and a messageID for each recipient. The “poll,” “answer,” and “contact” business objects may be mapped on the back end (e.g., by application server 130) to maintain relationships between the data attributes.

After all steps have been completed, device 110 may send the generated data to application server 130. Application server 130 may generate an SMS from the pollString, answerLabels, and answerStrings. Before the message is sent, messageID services of application server 130 may select at least one phone number from those specified at 460 that has not sent an active poll to the current recipient's phone number. Application server 130 may send the SMS to each selected phone number.

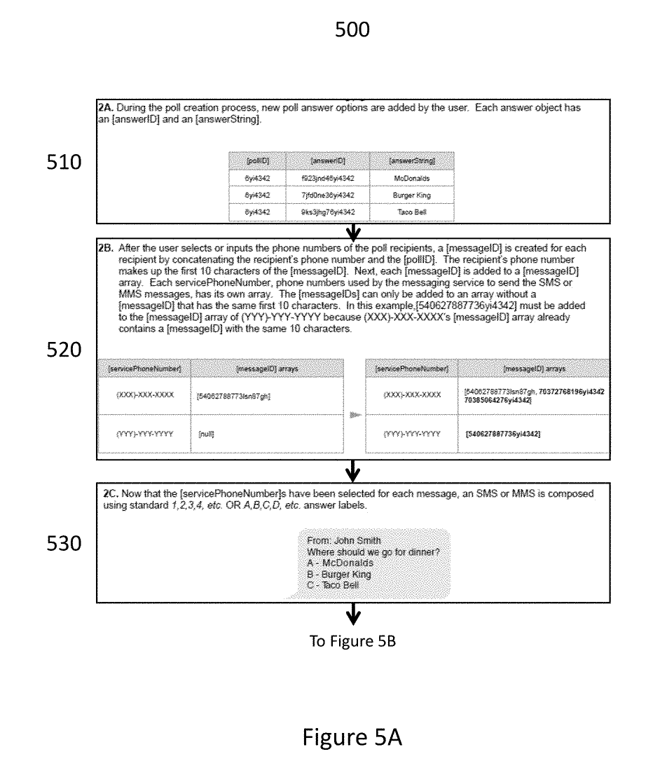

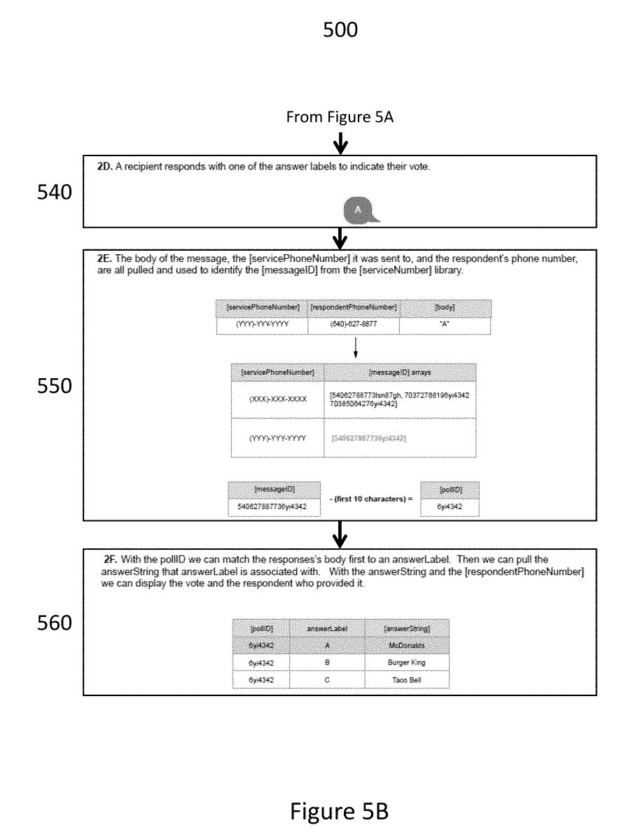

FIGS. 5A-5B show a polling method 500 according to an embodiment of the invention. For example, when device 110 has gathered and sent poll data to application server 130 in the process 400 of FIG. 4, application 130 may perform polling method 500 to generate, send, receive, and determine results for one or more polls.

At 510, application server 130 may receive data from device 110. For example, as shown, application server 130 may receive pollID, answerID, and/or answerString data generated by device 110 as discussed above. Application server 130 may also receive toPhoneNumber and messageID information as discussed above.

At 520, application server 130 may analyze the received data to determine servicePhoneNumbers for message recipients. For example, application server 130 may use a library of temporary associations between the phone numbers (servicePhoneNumber) provided by the messaging service and active messageIDs. For each contact to which the SMS poll is to be sent, application server 130 may scan each servicePhoneNumber's messageID array for a messageID whose first 10 characters match toPhoneNumber. The first servicePhoneNumber scanned without a matching messageID may be selected. As discussed below, application server 130 may send the SMS to the toPhoneNumber. When this happens, application server 130 may add the messageID of that poll to the array associated with that servicePhoneNumber. This may occur for each contact the user has selected as a recipient.

Application server 130 may include a messageID array maintenance service that clears inactive messageID's from the messageID arrays when their associated poll expires. This may be possible because every messageID ends with a pollID, which can tag a messageID as inactive if the associated pollExpiration date has passed. This process may ensure that no servicePhoneNumber has more than one active poll sent to a single phone number.

At 530, application server 130 may compose the SMS message (or MMS message in some embodiments) to be sent to the selected number. As shown in the example of FIG. 5A, application server 130 may insert question and answer string data from device 110 into the message body. Application server 130 may send the composed message to the specified numbers and/or contacts using SMS or MMS messaging. Step 530 may be repeated for all selected numbers.

At 540, application server 130 may receive one or more votes from one or more recipient mobile devices 120. Recipients of the SMS poll can vote by responding with an SMS message containing the answerLabel associated with the answer option they wish to select. When application server 130 receives this message, application server 130 may pull the following data: the servicePhoneNumber, the fromPhoneNumber, and the body of the SMS, for example.

At 550, application server 130 may scan the first 10 characters of each messageID associated with each servicePhoneNumber for the fromPhoneNumber. Once a matching messageID is found, application server 130 may parse the pollID from the matching messageID. The pollID may allow application server 130 to find the answerLabels and their respective answerStrings to match against the SMS response's body.

At 560, with the answerString, pollID, and messageID, application server 130 may report the answer option (answerString) and the voter (fromPhoneNumber) within the context of a specific poll. For example, application server 130 may save this result in an application server 130 database. Application server 130 may send the result to device 110, and device 110 may display the result in a user interface of the polling application.

Example System Architecture

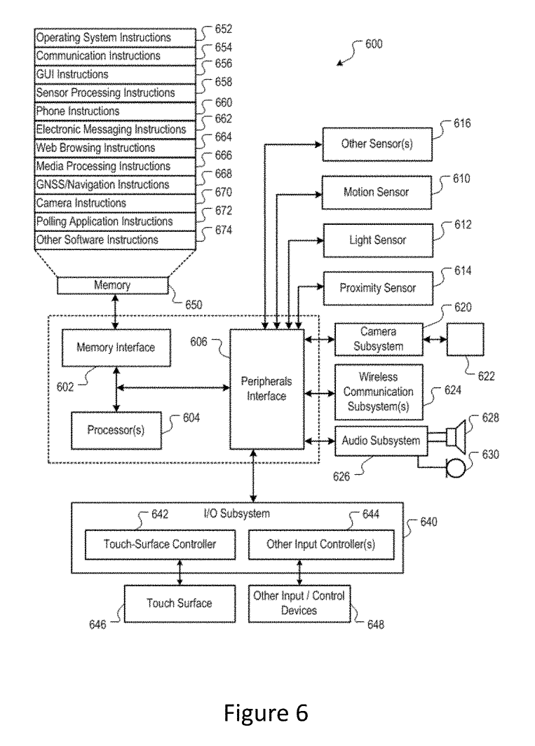

FIG. 6 is a block diagram of an example computing device 600 that may implement the features and processes of FIGS. 1-5B. For example, computing device 600 may determine and display location information and/or may receive location information from a server and display the received location information. The computing device 600 may include a memory interface 602, one or more data processors, image processors, and/or central processing units 604, and a peripherals interface 606. The memory interface 602, the one or more processors 604, and/or the peripherals interface 606 may be separate components or may be integrated in one or more integrated circuits. The various components in the computing device 600 may be coupled by one or more communication buses or signal lines.

Sensors, devices, and subsystems may be coupled to the peripherals interface 606 to facilitate multiple functionalities. For example, a motion sensor 610, a light sensor 612, and a proximity sensor 614 may be coupled to the peripherals interface 606 to facilitate orientation, lighting, and proximity functions. Other sensors 616 may also be connected to the peripherals interface 606, such as a global navigation satellite system (GNSS) (e.g., GPS receiver), a temperature sensor, a biometric sensor, magnetometer, or other sensing device, to facilitate related functionalities.

A camera subsystem 620 and an optical sensor 622, e.g., a charged coupled device (CCD) or a complementary metal-oxide semiconductor (CMOS) optical sensor, may be utilized to facilitate camera functions, such as recording photographs and video clips. The camera subsystem 620 and the optical sensor 622 may be used to collect images of a user to be used during authentication of a user, e.g., by performing facial recognition analysis.

Communication functions may be facilitated through one or more wireless communication subsystems 624, which can include radio frequency receivers and transmitters and/or optical (e.g., infrared) receivers and transmitters. For example, the BTLE and/or WiFi communications described above may be handled by wireless communication subsystems 624. The specific design and implementation of the communication subsystems 624 may depend on the communication network(s) over which the computing device 600 is intended to operate. For example, the computing device 600 may include communication subsystems 624 designed to operate over a GSM network, a GPRS network, an EDGE network, a WiFi or WiMax network, and a Bluetooth™ network. For example, the wireless communication subsystems 624 may include hosting protocols such that the device 600 can be configured as a base station for other wireless devices and/or to provide a WiFi service.

An audio subsystem 626 may be coupled to a speaker 628 and a microphone 530 to facilitate voice-enabled functions, such as speaker recognition, voice replication, digital recording, and telephony functions. The audio subsystem 626 may be configured to facilitate processing voice commands, voiceprinting, and voice authentication, for example.

The I/O subsystem 640 may include a touch-surface controller 642 and/or other input controller(s) 644. The touch-surface controller 642 may be coupled to a touch surface 646. The touch surface 646 and touch-surface controller 642 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 646.

The other input controller(s) 644 may be coupled to other input/control devices 648, such as one or more buttons, rocker switches, thumb-wheel, infrared port, USB port, and/or a pointer device such as a stylus. The one or more buttons (not shown) may include an up/down button for volume control of the speaker 628 and/or the microphone 630.

In one implementation, a pressing of the button for a first duration may disengage a lock of the touch surface 646; and a pressing of the button for a second duration that is longer than the first duration may turn power to the computing device 600 on or off. Pressing the button for a third duration may activate a voice control, or voice command, module that enables the user to speak commands into the microphone 630 to cause the device to execute the spoken command. The user may customize a functionality of one or more of the buttons. The touch surface 646 can, for example, also be used to implement virtual or soft buttons and/or a keyboard.

In some implementations, the computing device 600 may present recorded audio and/or video files, such as MP3, AAC, and MPEG files. In some implementations, the computing device 600 may include the functionality of an MP3 player, such as an iPod™. The computing device 600 may, therefore, include a 36-pin connector and/or 6-pin connector that is compatible with the iPod. Other input/output and control devices may also be used.

The memory interface 602 may be coupled to memory 650. The memory 650 may include high-speed random access memory and/or non-volatile memory, such as one or more magnetic disk storage devices, one or more optical storage devices, and/or flash memory (e.g., NAND, NOR). The memory 650 may store an operating system 652, such as Darwin, RTXC, LINUX, UNIX, OS X, WINDOWS, or an embedded operating system such as VxWorks.

The operating system 652 may include instructions for handling basic system services and for performing hardware dependent tasks. In some implementations, the operating system 652 may be a kernel (e.g., UNIX kernel). In some implementations, the operating system 652 may include instructions for performing voice authentication.

The memory 650 may also store communication instructions 654 to facilitate communicating with one or more additional devices, one or more computers and/or one or more servers. The memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GNSS/Navigation instructions 668 to facilitate GNSS and navigation-related processes and instructions; and/or camera instructions 670 to facilitate camera-related processes and functions.

The memory 650 may store polling application instructions 672 to facilitate other processes and functions, such as the polling processes and functions as described with reference to FIGS. 1-5B.

The memory 650 may also store other software instructions 674, such as web video instructions to facilitate web video-related processes and functions; and/or web shopping instructions to facilitate web shopping-related processes and functions. In some implementations, the media processing instructions 666 may be divided into audio processing instructions and video processing instructions to facilitate audio processing-related processes and functions and video processing-related processes and functions, respectively.

Each of the above identified instructions and applications may correspond to a set of instructions for performing one or more functions described above. These instructions need not be implemented as separate software programs, procedures, or modules. The memory 650 may include additional instructions or fewer instructions. Furthermore, various functions of the computing device 600 may be implemented in hardware and/or in software, including in one or more signal processing and/or application specific integrated circuits.

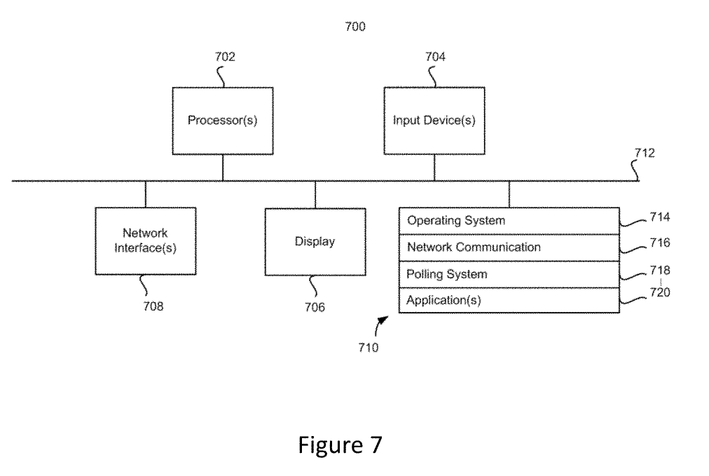

FIG. 7 is a block diagram of an example system architecture 700 that may implement the features and processes of FIGS. 1-5B. In some embodiments, computing device 600 may cooperate with system architecture 700 to perform polling as described above.

The architecture 700 may be implemented on any electronic device that runs software applications derived from compiled instructions, including without limitation personal computers, servers, smart phones, media players, electronic tablets, game consoles, email devices, etc. In some implementations, the architecture 700 may include one or more processors 702, one or more input devices 704, one or more display devices 706, one or more network interfaces 708, and one or more computer-readable mediums 710. Each of these components may be coupled by bus 712.

Display device 706 may be any known display technology, including but not limited to display devices using Liquid Crystal Display (LCD) or Light Emitting Diode (LED) technology. Processor(s) 702 may use any known processor technology, including but not limited to graphics processors and multi-core processors. Input device 704 may be any known input device technology, including but not limited to a keyboard (including a virtual keyboard), mouse, track ball, and touch-sensitive pad or display. Bus 712 may be any known internal or external bus technology, including but not limited to ISA, EISA, PCI, PCI Express, NuBus, USB, Serial ATA or FireWire. Computer-readable medium 710 may be any medium that participates in providing instructions to processor(s) 702 for execution, including without limitation, non-volatile storage media (e.g., optical disks, magnetic disks, flash drives, etc.), or volatile media (e.g., SDRAM, ROM, etc.).

Computer-readable medium 710 may include various instructions 714 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 may establish and maintain network connections (e.g., software for implementing communication protocols, such as TCP/IP, HTTP, Ethernet, etc.).

A polling system 718 can include instructions that may use or implement the processes described in reference to FIGS. 1-5B as described above. Application(s) 720 may be an application that uses or implements the processes described in reference to FIGS. 1-5B. The processes may also be implemented in operating system 714.

The described features may be implemented advantageously in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

### Conclusion

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A polling method comprising:
receiving, at an application server, poll creation data comprising a poll identifier, a poll question string, at least two answer identifiers and associated answer strings, and data identifying at least one recipient;
generating, by the application server, a plurality of unique data based on at least a portion of the poll creation data, the plurality of unique data enabling the identification of each of a plurality of poll message recipients;
generating, by the application server, a poll message comprising at least a portion of the poll creation data;
sending, by the application server, the poll message to each of the plurality of poll message recipients;
receiving, by the application server, at least one poll response; and
using, by the application server, the plurality of unique data to identify at least one sender of the at least one poll response and a selected poll answer.

2. The method of claim 1, wherein
the data identifying the at least one recipient comprises contact information; and
generating the plurality of unique data comprises associating an answer label with each answer identifier.

3. The method of claim 2, wherein:
using the plurality of unique data to identify the at least one sender of the at least one poll response comprises matching the contact information with sender information embedded in the at least one poll response; and
using the plurality of unique data to identify the selected poll answer comprises identifying the answer label and the answer identifier within the at least one poll response.

4. The method of claim 3, wherein the poll creation data further comprises a poll expiration time, the method further comprising making available for assignment a previously assigned answer label that was previously assigned to a poll that has expired.

5. The method of claim 1, wherein
the poll creation data further comprises an answer label for each answer identifier;
the data identifying the at least one recipient comprises a phone number; and
generating the plurality of unique data comprises creating a message identifier from the poll identifier and the phone number.

6. The method of claim 5, wherein:
using the plurality of unique data to identify the at least one sender of the at least one poll response comprises matching the phone number with sender information embedded in the at least one poll response; and
using the plurality of unique data to identify the selected poll answer comprises identifying the answer identifier within the at least one poll response and using the answer identifier to look up the answer label for the selected poll answer.

7. The method of claim 6, wherein the poll creation data further comprises a poll expiration time, the method further comprising clearing an answer label that was previously assigned to a poll that has expired from a memory.

8. A polling system comprising:
an application server memory; and
an application server processor coupled to the application server memory and configured to:
receive poll creation data comprising a poll identifier, a poll question string, at least two answer identifiers and associated answer strings, and data identifying at least one recipient;
generate a plurality of unique data based on at least a portion of the poll creation data, the plurality of unique data enabling the identification of each of a plurality of poll message recipients;
generate a poll message comprising at least a portion of the poll creation data;
send the poll message to each of the plurality of poll message recipients;
receive at least one poll response; and
use the plurality of unique data to identify at least one sender of the at least one poll response and a selected poll answer.

9. The system of claim 8, wherein
the data identifying the at least one recipient comprises contact information; and
the application server processor is configured to generate the plurality of unique data by a process comprising associating an answer label with each answer identifier.

10. The system of claim 9, wherein:
the application server processor is configured to use the plurality of unique data to identify the at least one sender of the at least one poll response by a process comprising matching the contact information with sender information embedded in the at least one poll response; and
the application server processor is configured to use the plurality of unique data to identify the selected poll answer by a process comprising identifying the answer label and the answer identifier within the at least one poll response.

11. The system of claim 9, wherein:
the poll creation data further comprises a poll expiration time; and
the application server processor is further configured to make available for assignment a previously assigned answer label that was previously assigned to a poll that has expired.

12. The system of claim 8, wherein
the poll creation data further comprises an answer label for each answer identifier;
the data identifying the at least one recipient comprises a phone number; and
the application server processor is configured to generate the plurality of unique data by a process comprising creating a message identifier from the poll identifier and the phone number.

13. The system of claim 12, wherein:
the application server processor is configured to use the plurality of unique data to identify the at least one sender of the at least one poll response by a process comprising matching the phone number with sender information embedded in the at least one poll response; and
the application server processor is configured to use the plurality of unique data to identify the selected poll answer by a process comprising identifying the answer identifier within the at least one poll response and using the answer identifier to look up the answer label for the selected poll answer.

14. The system of claim 13, wherein:
the poll creation data further comprises a poll expiration time; and
the application server processor is further configured to clear an answer label that was previously assigned to a poll that has expired from the application server memory.

15. The system of claim 8, further comprising a mobile device configured to:
create the poll creation data; and
send the poll creation data to the application server processor.

16. The system of claim 8, further comprising a mobile device configured to:
receive the poll message;
generate the at least one poll response; and
send the at least one poll response to the application server processor.
